(19) United States
(12) Patent Application Publication
(10) Pub. No.: US 2004/0246987 A1
(43) Pub. Date: Dec. 9, 2004

(54) Space qualified local area network

(76) Inventors: Evan H. Webb, Elkridge, MD (US); Michael R. Lin, Ellicott City, MD (US); Scott E. Edfors, Silver Spring, MD (US)

Correspondence Address: NASA GODDARD SPACE FLIGHT CENTER, OFFICE OF PATENT COUNSEL, MAIL CODE 503, GREENBELT, MD, 20771, US

(21) Appl. No.: 10/794,604

(22) Filed: Mar. 5, 2004

Related U.S. Application Data
(60) Provisional application No. 60/453,332, filed on Mar. 5, 2003.

(51) Int. Cl. H04L 12/66

(52) U.S. Cl. 370/463; 370/419

(57) ABSTRACT

A space qualified local area network includes a plurality of stations, a switch in communication with the plurality of stations, and a network interface controller associated with each station. The network interface controller includes a media access controller having a medium-independent interface and a physical layer. The physical layer includes a data-strobe encoder for combining a first data signal and a strobe signal to produce an output signal, a low voltage differential signaling driver for transmitting the output signal, a low voltage differential signaling receiver for receiving an input signal, and a clock recovery decoder for extracting a second data signal and a clock signal from the input signal.

This application claims benefit of priority under 35 U.S.C. § 119 of U.S. Provisional Patent Application No. 60/453,332, filed Mar. 5, 2003, which is incorporated herein by reference.

The invention described herein was made by employees and a contractor of the United States Government and may be manufactured and used by or for the Government of the United States of America for governmental purposes without the payment of any royalties thereon or therefor.

### BACKGROUND OF THE INVENTION

1. Field of the Invention

The present invention relates to a communications system and, more particularly, to a space qualified local area network.

2. Description of the Related Art

Reliability in sending and receiving commands and telemetry is essential for the operation of a spacecraft. Because of its reliability, the MIL-STD-1553 data bus has been established as a standard for passing commands on a spacecraft, such as, for example, sending commands from the Command & Data Handling (C&DH) computer to other onboard subsystems.

Although the MIL-STD-1553 data bus is reliable, it is relatively slow, having a data rate of less than 1 Mbps. Accordingly, on most spacecraft it has been necessary to create separate, custom, high-speed interfaces between the science instruments and either the data recorder, science computer, or communications system to accommodate the large volume of data from the instruments. Other custom interfaces have included discrete controls for devices not on the 1553 bus and discrete interfaces for timing. An example of a conventional spacecraft data network 20 having a 1553 bus 22 and several custom interfaces 24 connecting several stations 26 is shown in FIG. 1.

The use of custom interfaces adds significantly to the overall cost of a spacecraft because of the need to develop a communications protocol and electrical standards, as well as the required hardware design, fabrication, and testing. Furthermore, these interfaces usually carry a large penalty to the spacecraft in terms of power, mass, and volume.

### SUMMARY OF EXEMPLARY ASPECTS

In the following description, certain aspects and embodiments of the present invention will become evident. It should be understood that the invention, in its broadest sense, could be practiced without having one or more features of these aspects and embodiments. It should also be understood that these aspects and embodiments are merely exemplary.

To overcome the drawbacks of the prior art and in accordance with the purpose of the invention, as embodied and broadly described herein, one aspect of the invention provides a local area network (LAN) comprising a plurality of stations, a switch in communication with the plurality of stations, and a network interface controller (NIC) associated with each station. As used herein, “station” means a node, such as, for example, a computer, on a network. A station is also commonly referred to as data terminal equipment (DTE). Further, as used herein, “network interface controller” encompasses both an Ethernet interface on its own card, commonly referred to as a network interface card, and an Ethernet interface in an embedded application on a station. In one example, the NIC may be located on an integrated circuit on a station's processor board. All references herein to “Ethernet” relate to IEEE standard 802.3.

The network interface controller comprises a media access controller (MAC) having a medium-independent interface (MII), and a physical layer (PHY). As used herein, “media access controller” and “medium-independent interface” are used in accordance with the definitions and conventions provided in IEEE standard 802.3, which is incorporated herein by reference.

The physical layer comprises a data-strobe (DS) encoder for combining a first data signal and a strobe signal to produce an output signal, a low voltage differential signaling (LVDS) driver for transmitting the output signal, a low voltage differential signaling receiver for receiving an input signal, and a clock recovery decoder for extracting a second data signal and a clock signal from the input signal.

In another aspect, the invention provides a space-qualified local area network comprising a switch, a plurality of stations communicating with the switch through a cable medium, and a network interface controller associated with each station. The switch and the stations may be disposed on a spacecraft.

The network interface controller comprises a media access controller having a medium-independent interface and a radiation hardened physical layer. As used herein, “radiation hardened” means a component remains functional up to 100 Krad (Si) total ionizing dose (TID) and/or is able to withstand a single event upset (SEU) of 40 MeV-gm/cm².

The radiation hardened physical layer comprises a data-strobe encoder for combining a first data signal and a strobe signal to produce an output signal, a low voltage differential signaling driver for transmitting the output signal to the cable medium, a low voltage differential signaling receiver for receiving an input signal from the cable medium, and a clock recovery decoder for extracting a second data signal and a clock signal from the input signal.

In a further aspect, the invention provides a network interface controller associated with each station of a local area network. The network interface controller comprises a media access controller having a medium-independent interface and an all digital physical layer. The all digital physical layer comprises an encoding element for combining a first data signal and a first clocking signal to produce an output signal, a low voltage differential signaling driver for transmitting the output signal, a low voltage differential signaling receiver for receiving an input signal, and a decoding element for extracting a second data signal and a second clocking signal from the input signal.

Aside from the structural and procedural arrangements set forth above, the invention could include a number of other arrangements, such as those explained hereinafter. It is to be understood that both the foregoing description and the following description are exemplary only.

### BRIEF DESCRIPTION OF THE DRAWINGS

The accompanying drawings, which are incorporated in and constitute a part of this specification, illustrate several exemplary embodiments of the invention and together with the description, serve to explain the principles of the invention. In the drawings,

FIG. 1 is a schematic view of a conventional spacecraft data network;

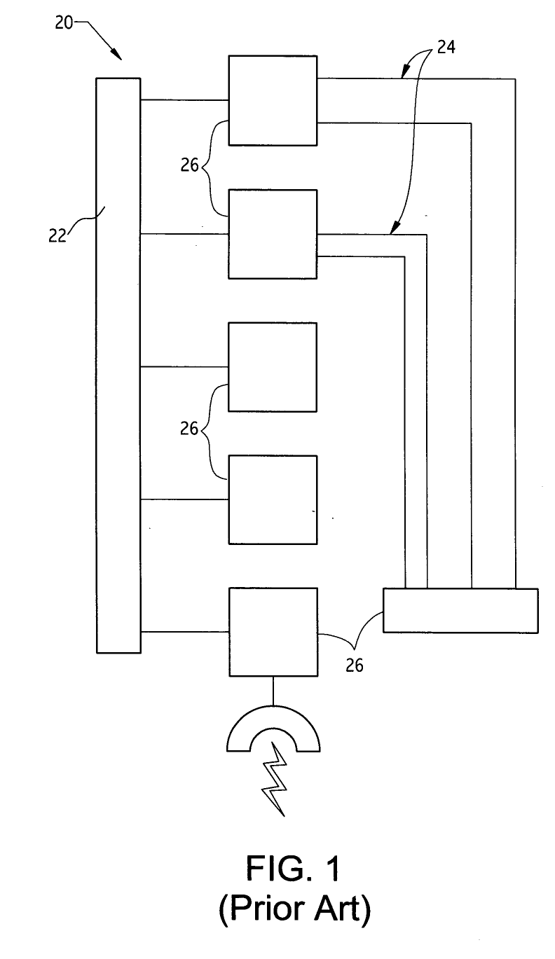

FIG. 2 is a schematic view of an embodiment of the local area network according to the present invention;

FIG. 3 is a block diagram of an embodiment of a network interface controller according to the present invention;

FIG. 4 is a block diagram of an embodiment of a physical layer according to the present invention;

FIG. 5 is a block diagram comparing two conventional physical layers to an embodiment of the physical layer according to the present invention;

FIG. 6 is a schematic view of another embodiment of the local area network according to the present invention;

FIG. 7 is a block diagram of another embodiment of a network interface controller according to the present invention.

### DETAILED DESCRIPTION OF EXEMPLARY EMBODIMENTS

Reference will now be made in detail to the exemplary embodiments of the invention, examples of which are illustrated in the accompanying drawings. Wherever possible, the same reference numbers will be used throughout the drawings to refer to the same or like parts.

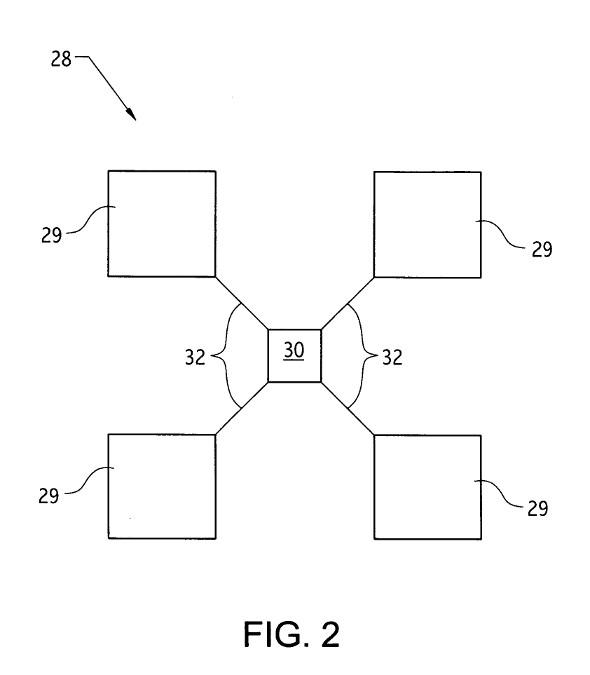

An embodiment of a LAN 28 according to the present invention is shown in FIG. 2. As shown, four stations 29 are in communication with a switch 30 through a cable medium 32. A different number of stations 29 may be used. The switch 30 uses a cut through-type technique and supports full-duplex mode.

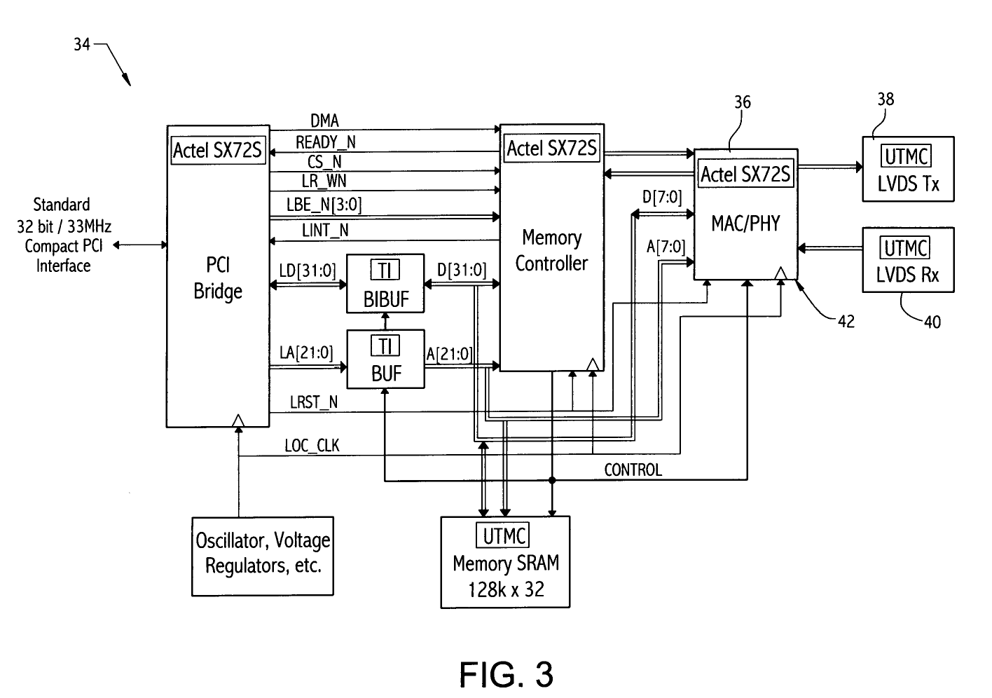

Each station 29 is provided with an NIC. A block diagram of an embodiment of an NIC 34 according to the invention is shown in FIG. 3. The NIC 34 utilizes a commercially available 10/100 Mbps MAC intellectual property (IP) core. The MAC core comprises the standard elements identified in the IEEE 802.3 standard, including an application interface, transmit and receive protocol engines, an MII, and a management interface for the configuration and maintenance of simple network management protocol (SNMP) objects.

In the embodiment shown in FIG. 3, the MAC and the PHY are contained on an ACTEL model SX72S field programmable gate array (FPGA) 36, which is radiation hardened. Other FPGAs may be used. Alternatively, the MAC and the PHY may be implemented on an application specific integrated circuit (ASIC). The PHY of this embodiment further comprises a radiation hardened LVDS driver 38 and receiver 40. In the illustrated embodiment, an AEROFLEX UTMC 3.3-volt Quad Driver and Quad Receiver are used. Other LVDS drivers and receivers may be used.

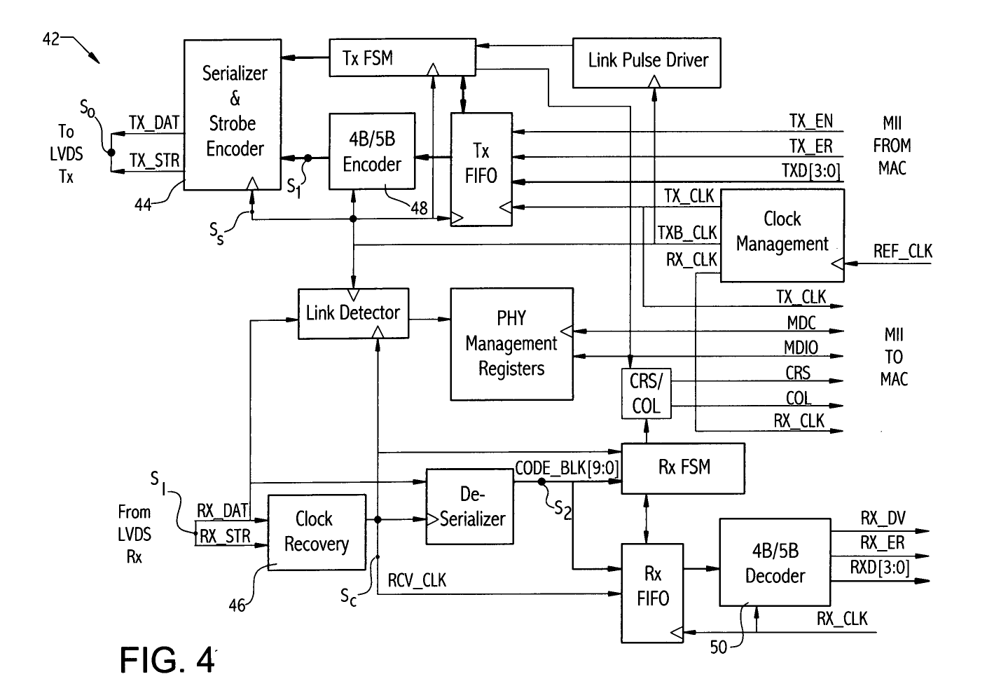

A block diagram of an embodiment of the PHY 42 according to the invention is shown in FIG. 4. The PHY 42 utilizes LVDS drivers and receivers and DS encoding with a four twisted-pair cable medium. In DS encoding, data is encoded on one twisted-pair and the strobe is encoded on the other twisted-pair. Thus, two twisted-pairs are utilized by the LVDS driver and two twisted-pairs are utilized by the LVDS receiver. In one embodiment, the four twisted-pair cable medium and the associated connector that are used are of the type specified in European Cooperation for Space Standardization standard ECSS-E-50-12A, which is incorporated herein by reference.

The DS encoding technique has several features that may be advantageous compared to other encoding techniques. First, DS encoding provides a lower frequency of transitions than an explicit clock and data interface. This results in a narrower power spectral density that may extend the allowable cable length. Further, DS encoding provides reliable clock recovery that allows for less complexity at the receiver than would a single twisted-pair cable implementing other encoding techniques.

As shown in FIG. 4, the DS encoder 44 combines a first data signal S₁ and the strobe signal S_{S} to produce the output signal S_{O}. The LVDS driver transmits the output signal on the cable medium.

Also shown in FIG. 4, the LVDS receiver receives an input signal S₁ on the cable medium. A clock recovery decoder 46 extracts a second data signal S₂ and the clock signal S_{C} from the input signal S₁.

The PHY 42 further utilizes a 4B/5B encoder 48 and decoder 50 for block encoding of the signals.

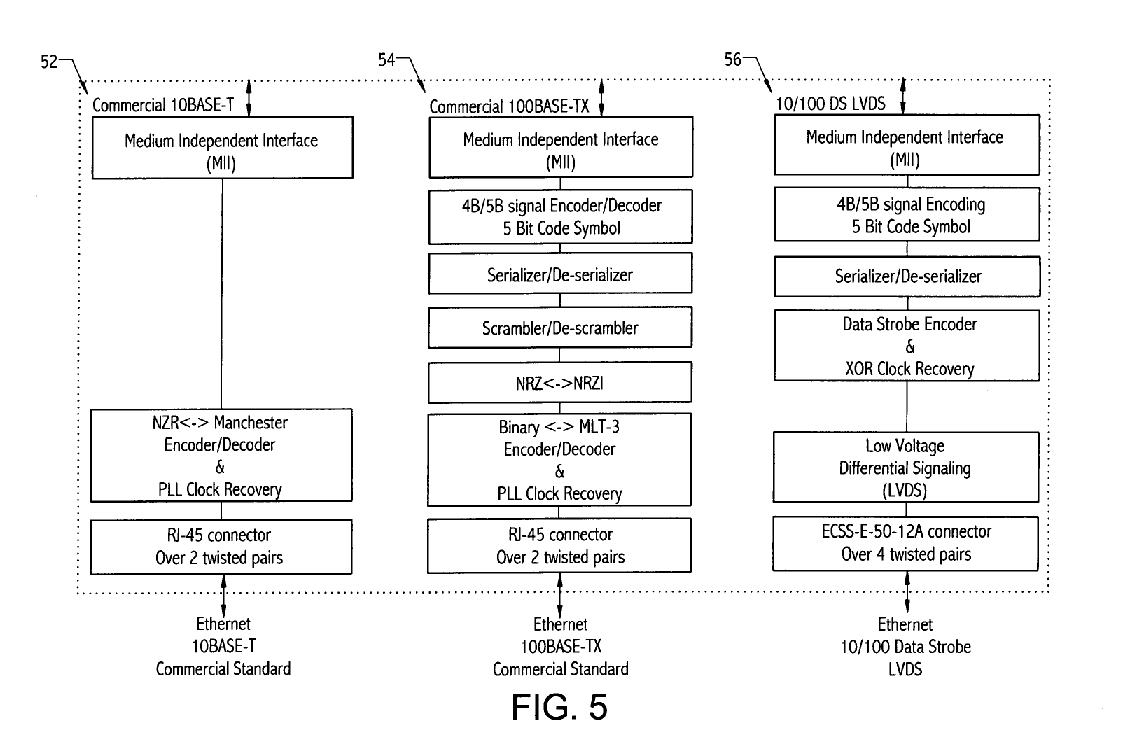

A comparison of two conventional PHYs 52, 54 to an embodiment of the PHY 56 according to the present invention is provided in FIG. 5. The conventional PHYs 52, 54 shown are the 10BASE-T PHY and the 100BASE-TX PHY. It is evident from FIG. 5 that the two conventional PHYs 52, 54 are combination analog/digital devices. In particular, the conventional PHYs 52, 54 utilize some analog signal processing to recover the clock signal and to interpret the data signal levels. By contrast, the PHY 56 according to the present invention is all digital. The all digital PHY 56 may be more robust and less sensitive to total dose degradation than the analog devices of conventional PHYs 52, 54. Further, the LVDS drivers consume less power than other devices and may result in lower system power consumption.

It is noted that the PHY 56 according to the present invention utilizing DS encoding and LVDS drivers is capable of operation at either 10 Mbps or 100 Mbps. In other words, the technology is scaleable.

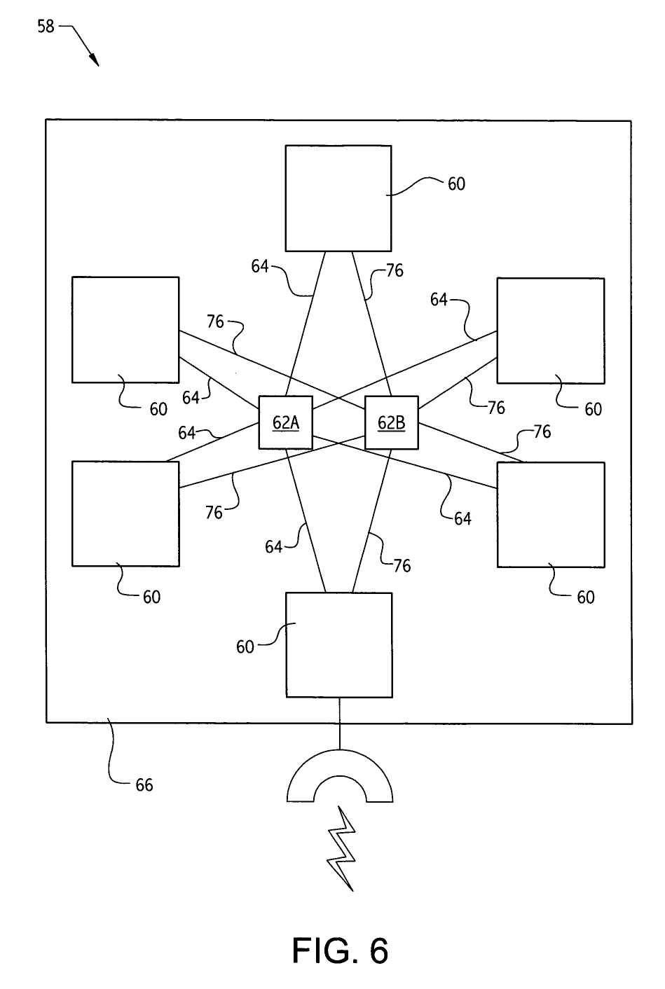

Another embodiment of the LAN 58 according to the present invention is shown in FIG. 6. A plurality of stations 60 communicate with a switch 62A through a cable medium 64. In this embodiment, the switch 62A and the stations 60 are disposed on a spacecraft 66. The switch 62A uses a cut through-type technique and supports full-duplex mode. The stations 60 comprise at least one of spacecraft subsystems and science instruments. As used herein, “spacecraft subsystems” means equipment used for operating and/or maintaining the spacecraft, including, for example, C&DH subsystems, attitude control electronics (ACE) subsystems, and power supply electronics (PSE) subsystems.

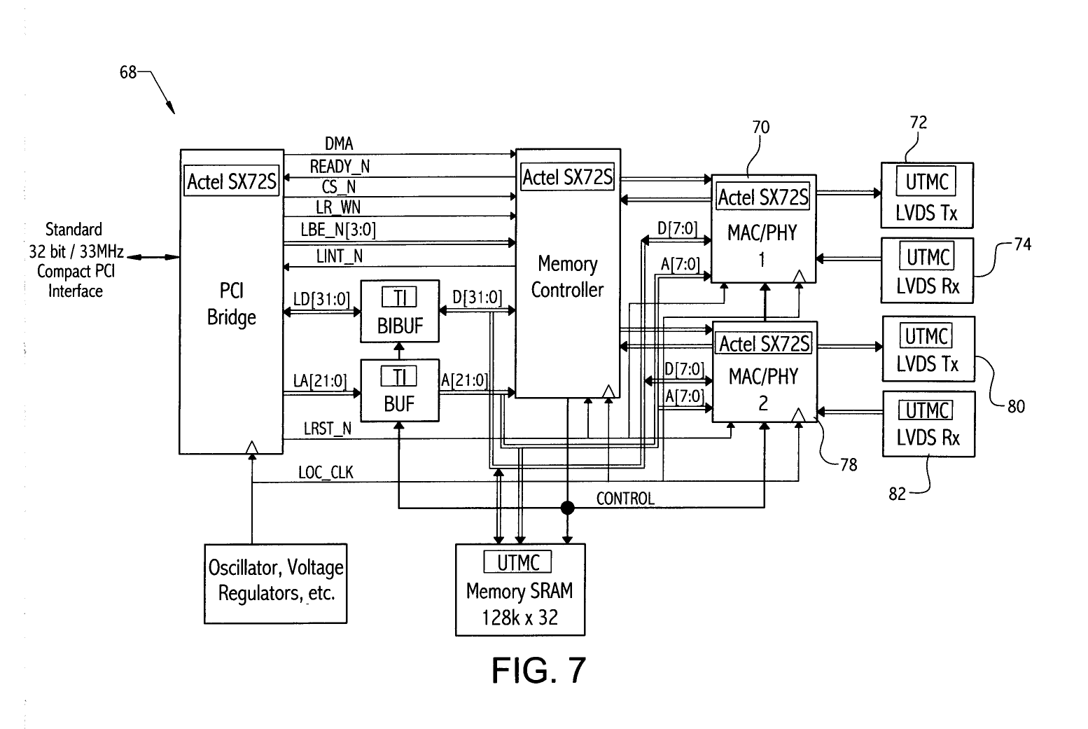

There is an NIC associated with each station. A block diagram of the NIC 68 of this embodiment is shown in FIG. 7. The NIC 68 has an MAC, an MII, and a PHY contained on a radiation hardened ACTEL model SX72S FPGA 70. The PHY comprises a DS encoder and decoder and an LVDS driver 72 and receiver 74.

Additionally, in this embodiment the LAN comprises a second cable medium 76 providing a redundant communication link between each station 60 and a second switch 62B. The second switch 62B also uses a cut through-type technique and supports full-duplex mode. Further, the NIC 68 comprises a second MAC having a second MII contained on a second radiation hardened ACTEL model SX72S FPGA 78. The NIC further comprises a second radiation hardened PHY having a second DS encoder and decoder and a second LVDS driver 80 and receiver 82.

Other modifications may be made to the system to meet varying network requirements.

It will be apparent to those skilled in the art that various modifications and variations can be made to the structure and methodology described herein. Thus, it should be understood that the invention is not limited to the examples discussed in the specification. Rather, the present invention is intended to cover modifications and variations.

What is claimed is:

1. A local area network, comprising:
a plurality of stations;
a switch in communication with the plurality of stations; and
a network interface controller associated with each station, the network interface controller comprising:
a media access controller having a medium-independent interface; and
a physical layer, the physical layer comprising:
a data-strobe encoder for combining a first data signal and a strobe signal to produce an output signal;
a low voltage differential signaling driver for transmitting the output signal;
a low voltage differential signaling receiver for receiving an input signal; and
a clock recovery decoder for extracting a second data signal and a clock signal from the input signal.

2. The local area network of claim 1, wherein the stations and the switch are disposed on a spacecraft.

3. The local area network of claim 2, wherein the stations comprise at least one of spacecraft subsystems and science instruments.

4. The local area network of claim 1, wherein the switch is configured to provide a full duplex connection between two stations.

5. The local area network of claim 1, wherein the switch communicates with each station through a cable medium.

6. The local area network of claim 5, wherein the cable medium comprises four twisted-pair cables.

7. The local area network of claim 1, wherein the physical layer is radiation hardened.

8. The local area network of claim 1, further comprising a block encoder for receiving first 4-bit blocks of data from the medium-independent interface and translating the first 4-bit blocks of data into first 5-bit code groups, wherein the first 5-bit code groups form the first data signal.

9. The local area network of claim 8, further comprising a block decoder for receiving second 5-bit code groups from the clock recovery decoder and translating the second 5-bit code groups into second 4-bit blocks of data, wherein the second 5-bit code groups form the second data signal.

10. A space-qualified local area network, comprising:
a switch;
a plurality of stations communicating with the switch through a cable medium, wherein the switch and the stations are disposed on a spacecraft; and
a network interface controller associated with each station, the network interface controller comprising:
a media access controller having a medium-independent interface; and
a radiation hardened physical layer, the radiation hardened physical layer comprising:
a data-strobe encoder for combining a first data signal and a strobe signal to produce an output signal;
a low voltage differential signaling driver for transmitting the output signal to the cable medium;
a low voltage differential signaling receiver for receiving an input signal from the cable medium; and
a clock recovery decoder for extracting a second data signal and a clock signal from the input signal.

11. The local area network of claim 10, wherein the stations comprise at least one of spacecraft subsystems and science instruments.

12. The local area network of claim 10, wherein the switch is configured to provide a full duplex connection between two stations.

13. The local area network of claim 10, wherein the cable medium comprises four twisted-pair cables.

14. The local area network of claim 10, further comprising:
a second switch; and
a second cable medium providing a redundant communication link between each station and the second switch.

15. The local area network of claim 14, wherein the network interface controller further comprises:
a second media access controller having a second medium-independent interface; and
a second radiation hardened physical layer, the second radiation hardened physical layer comprising:
a second data-strobe encoder for combining the first data signal and the strobe signal to produce a second output signal;
a second low voltage differential signaling driver for transmitting the second output signal to the cable medium;
a second low voltage differential signaling receiver for receiving the input signal from the cable medium; and
a second clock recovery decoder for extracting the second data signal and the clock signal from the input signal.

16. A local area network, comprising:
a plurality of stations;
a switch in communication with the plurality of stations; and
a network interface controller associated with each station, the network interface controller comprising:
a media access controller having a medium-independent interface; and
an all digital physical layer, the physical layer comprising:
an encoding element for combining a first data signal and a first clocking signal to produce an output signal;
a low voltage differential signaling driver for transmitting the output signal;
a low voltage differential signaling receiver for receiving an input signal; and
a decoding element for extracting a second data signal and a second clocking signal from the input signal.
